(19) United States
(12) Patent Application Publication
(10) Pub. No.: US 2025/0172488 A1
(43) Pub. Date: May 29, 2025

(54) WIDE-SPECTRUM ANALYSIS SYSTEM

(71) Applicant: Bio-Rad Laboratories, Inc., Hercules, CA (US)

(72) Inventors: Stephen L. SWIHART, Walnut Creek, CA (US); Evan THRUSH, San Anselmo, CA (US)

(73) Assignee: Bio-Rad Laboratories, Inc., Hercules, CA (US)

(21) Appl. No.: 18/841,353

(22) PCT Filed: Feb. 27, 2023
(86) PCT No.: PCT/US2023/063379

§ 371 Date: Aug. 23, 2024

Related U.S. Application Data
(60) Provisional application No. 63/314,939, filed on Feb. 28, 2022.

(51) Int. Cl. G01N 21/25; G01N 21/64

(52) U.S. Cl. CPC G01N 21/255; G01N 21/251; G01N 21/645; G01N 2021/6419; G01N 2021/6421

(57) ABSTRACT

A wide-spectrum analysis system. The system may comprise various components, including a stage, a detection module, and an optical relay structure. The stage may be configured to support a sample holder—a gel or blot, a PCR plate or microplate, sample chips, or a microfluidic device, among others—at an examination region. The detection module may be configured to detect light originating from one or more samples positioned in the sample holder. The detection module may be configured to detect light having wavelengths between about 200 nm and about 2000 nm, or subsets thereof. The optical relay structure may be configured to direct the output light from the examination region to the detection module. The system may further comprise an illumination module. Embodiments of the analyzer may be suitable for use with one or more of the following interrogation formats, among others: chemiluminescence, fluorescence, colorimetry, and spectrometry.

### CROSS-REFERENCE TO PRIORITY APPLICATION

This application is based upon and claims the benefit under 35 U.S.C. § 119 (e) of U.S. Provisional Patent Application Ser. No. 63/314,939, filed Feb. 28, 2022, which is incorporated herein by reference in its entirety for all purposes.

### INTRODUCTION

Optics-based analysis systems play important roles in basic science, industry, pharmaceutical and medical research, and diagnostics, among others. These systems often involve detection and analysis of light from multiple samples. Information derived from the analysis may include a presence, absence, identity, quantity, extent, and/or activity of a composition or reaction. Exemplary analysis systems may employ blots or gels with many bands and multi-well plates with many sample wells, among others. Unfortunately, the number of sample types that can be studied using a single blot or gel or multi-well plate currently is limited. Therefore, there is a need for a system that can analyze additional samples types without requiring additional sample holders and/or additional instruments.

### SUMMARY

The present disclosure provides a wide-spectrum analysis system, including apparatus and methods. The system may comprise various components, including a stage, a detection module, and an optical relay structure. The stage may be configured to support a sample holder—a gel or blot, a PCR plate or microplate, sample chips, or a microfluidic device, among others—at an examination region. The detection module may be configured to detect light originating from one or more samples positioned in the sample holder. The detection module may be configured to detect light having wavelengths between about 200 nm and about 2000 nm, or subsets thereof, depending on the embodiment. Finally, the optical relay structure may be configured to direct the output light from the examination region to the detection module. In some embodiments, the system may further comprise an illumination module. The illumination module may include one or more discrete light sources, such as LEDs or lasers, capable of exciting fluorescence and/or otherwise inducing colored output light from the samples. Embodiments of the analyzer may be suitable for use with one or more of the following interrogation formats, among others: chemiluminescence, fluorescence, colorimetry, and spectrometry. Significantly, the system may allow analysis of more samples, or sample types, than previous systems.

### BRIEF DESCRIPTION OF THE DRAWINGS

FIG. 1 is a schematic view of an exemplary wide-spectrum analysis system, including a stage, an illumination module, a detection module, and an optical relay structure.

FIG. 2 is a schematic view of a first exemplary sample holder, configured as a gel or a blot, suitable for use with the analysis systems of the present disclosure.

FIG. 3 is a schematic view of a second exemplary sample holder, configured as a multi-well plate, such as a PCR plate or a microplate, suitable for use with the analysis systems of the present disclosure.

FIG. 4 is a schematic view of a third exemplary sample holder, configured as a microfluidic device, suitable for use with the analysis systems of the present disclosure.

FIG. 5 is a schematic view of a first alternative exemplary wide-field analysis system, distinguished by its lack of an illumination module. In this embodiment, the optical relay structure includes a lens configured to capture and direct output light onto the detection module and a filter configured to alter an aspect of that light prior to its reaching the detection module.

FIG. 6 is a schematic view of a second alternative wide-spectrum analysis system, distinguished by its off-axis illumination module. In this embodiment, the optical relay structure includes lenses for capturing and directing illumination light and output light and filters configured to alter aspects of that light prior to its irradiating the sample and its reaching the detection module, respectively.

FIG. 7 is a schematic view of a third alternative wide-spectrum analysis system, distinguished by its epi-illumination module. In this embodiment, the optical relay structure includes lenses for capturing and directing illumination light and output light and filters configured to alter aspects of that light prior to its irradiating the sample and its reaching the detection module, respectively.

FIG. 8 is a schematic view of a fourth alternative wide-spectrum analysis system, distinguished by its trans-illumination module. In this embodiment, the optical relay structure includes lenses for capturing and directing illumination light and output light and filters configured to alter aspects of that light prior to its irradiating the sample and its reaching the detection module, respectively.

FIG. 9 is a schematic view of a fifth exemplary alternative wide-spectrum analysis system, distinguished by its spectral separator for separating the output light spatially according to wavelength before the light reaches the detection module.

FIG. 10 is a schematic view of exemplary images of a colored sample formed by embodiments of the analysis system, showing monochrome images corresponding to different colors, and a composite image simultaneously portraying all of the colors.

FIG. 11 is a schematic view of an exemplary image of a spectrum of a colored sample formed by embodiments of the analysis system, such as the embodiment of FIG. 9.

### DEFINITIONS

Technical terms used in this disclosure have the meanings that are commonly recognized by those skilled in the art. However, the following terms may have additional meanings, as described below. The wavelength ranges identified in these meanings are exemplary, not limiting, and may overlap slightly, depending on source or context. The wavelength ranges lying between about 1 nm and about 1 mm, which include ultraviolet, visible, and infrared radiation, and which are bracketed by x-ray radiation and microwave radiation, may collectively be termed optical radiation.

Ultraviolet radiation. Electromagnetic radiation invisible to the human eye and having wavelengths from about 100 nm, just longer than x-ray radiation, to about 400 nm, just shorter than violet light in the visible spectrum. Ultraviolet radiation includes (1) UV-C (from about 100 nm to about 280 or 290 nm), (2) UV-B (from about 280 or 290 nm to about 315 or 320 nm), and (3) UV-A (from about 315 or 320 nm to about 400 nm).

Visible light. Electromagnetic radiation visible to the normal human eye and having wavelengths from about 360 or 400 nanometers, just longer than ultraviolet radiation, to about 760 or 800 nanometers, just shorter than infrared radiation. Visible light typically may be imaged and detected by the unaided human eye and includes violet (about 390-425 nm), indigo (about 425-445 nm), blue (about 445-500 nm), green (about 500-575 nm), yellow (about 575-585 nm), orange (about 585-620 nm), and red (about 620-740 nm) light, among others.

Infrared (IR) radiation. Electromagnetic radiation invisible to the human eye and having wavelengths from about 700 or 800 nanometers, just longer than red light in the visible spectrum, to about 1 millimeter, just shorter than microwave radiation. Infrared radiation includes (1) IR-A (from about 700 nm to about 1,400 nm), (2) IR-B (from about 1,400 nm to about 3,000 nm), and (3) IR-C (from about 3,000 nm to about 1 mm). IR radiation, particularly IR-C, may be caused or produced by heat and may be emitted by an object in proportion to its temperature and emissivity. This thermal emission is important for night-vision systems but otherwise, as here, may represent unwanted background radiation. Interest in relatively shorter wavelength IR has led to the following classifications: (1) near infrared (NIR) (from about 780 nm to about 1,000 nm (1 μm)), and (2) short-wave infrared (SWIR) (from about 1,000 nm (1 μm) to about 3,000 nm (3 μm)).

### DETAILED DESCRIPTION

The present disclosure provides a wide-spectrum analysis system, including apparatus and methods, for analysis of multiple samples or sample types. The system may comprise various components, including a stage, a detection module, and an optical relay structure. The stage may be configured to support a sample holder—a gel or blot, a PCR plate or microplate, a sample chip, and/or a microfluidic device, among others—at an examination region. The detection module may be configured to detect light originating from one or more samples positioned in the sample holder. The detected light may have wavelengths between about 200 nm and about 2000 nm, or a subset or subsets thereof, depending on the embodiment. Finally, the optical relay structure may be configured to direct the output light from the examination region to the detection module. In some embodiments, the system may further comprise an illumination module configured to produce illumination light for irradiating a sample positioned in the sample holder at the examination region. In these embodiments, the optical relay structure may be configured both to direct light from the illumination module to the sample holder and from the sample holder to the detection module. The illumination module may include one or more discrete light sources, such as LEDs or lasers, capable of exciting fluorescence and/or otherwise inducing colored output light from the samples. Embodiments of the analyzer may be suitable for use with one or more of the following interrogation formats, among others: fluorescence, chemiluminescence, colorimetry, and spectrometry. Further aspects of the analysis system are described below.

### I. Wide-Spectrum Fluorescence Analyzer

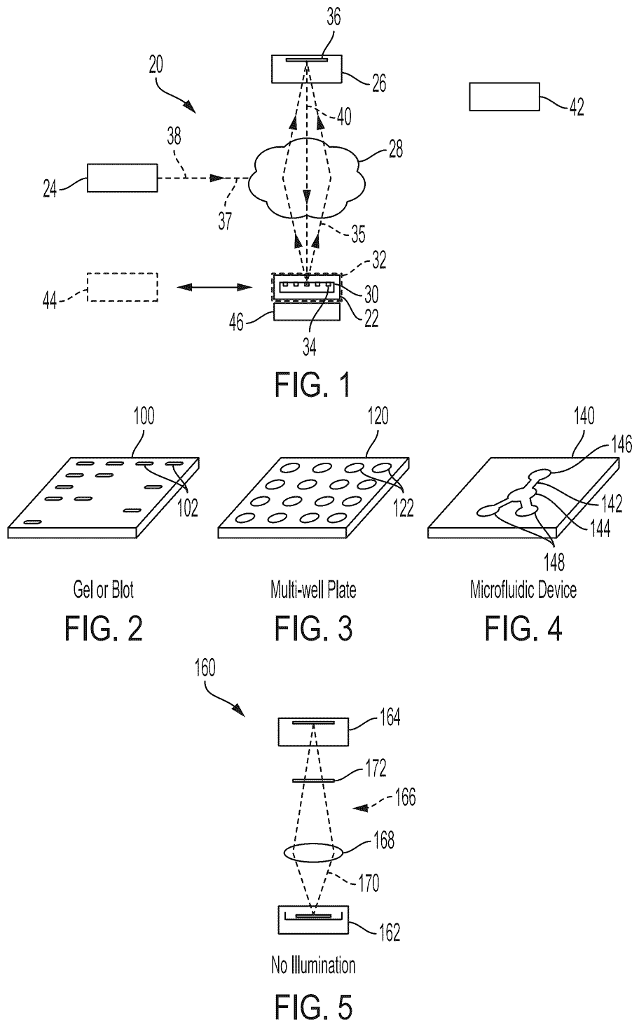

FIG. 1 is a high-level schematic view of an exemplary wide-spectrum analysis system 20, in accordance with aspects of the present disclosure. The system may include a stage 22, an illumination module 24, a detection module 26, and an optical relay structure 28. The stage may be configured to support a sample holder 30, such as a gel or blot or multi-well plate or microfluidic device, at an examination region 32. The sample holder, in turn, may support one or more samples 34 for analysis. The illumination module, which is only present in a subset of embodiments, may be configured to produce illumination light for irradiating a sample positioned in the sample holder at the examination region. The detection module may be configured to detect output light 35 originating from the sample(s) and to form an image 36, such as a two-dimensional image of light intensities, which typically will be represented electronically. The optical relay structure may be configured to direct illumination light 37 from the illumination module, when present, along an illumination path 38 to the sample(s), and to direct output light along an output path 40 from the sample(s) to the detection module. The optical relay structure may include one or more lenses, mirrors, beamsplitters, and/or other optics to direct light and one or more filters and/or other elements to eliminate stray and/or otherwise unintended light. The system further may include a controller 42 configured to manage at least one of the stage, the detection module, and the optical relay structure.

The stage generally comprises any structure configured to support a sample holder during analysis. The stage may be further configured to move the sample holder into and out of the examination region for such detection. For example, a user may place and retrieve sample holders from an input/output region 44, and the stage may move (↔) the sample holders between the input/output region and the examination region. Alternatively, or in addition, the stage may include a heating block 46 or other structure(s) configured to control or cycle the temperature of the sample, for example, for PCR or enzyme analysis.

The sample holder generally comprises any substrate or other mechanism for holding samples for wide-spectrum analysis. The sample holder may hold one or more discrete samples at one or more distinct sample sites. In some cases, sample sites may be defined by mechanical barriers, such as walls, for example, forming sample wells. In other cases, sample sites may be defined by (1) chemical barriers, such as hydrophobic regions separating hydrophilic regions, (2) steric barriers, such as intervening portions of a gel or blot, and/or (3) binding sites for nucleic acids, proteins, and/or other materials. The sample sites may be separate fluid volumes or share a common fluid volume. Exemplary sample holders with separate volumes may include PCR plates and microplates, among others. Exemplary sample holders with a common fluid volume may include gels, blots, sample chips, and microfluidic systems, among others. The samples themselves may be independent of one another or aliquots or replicates of one another, depending on the analysis. They also may be control or calibration samples. Exemplary sample holders are described further below in connection with FIGS. 2-4.

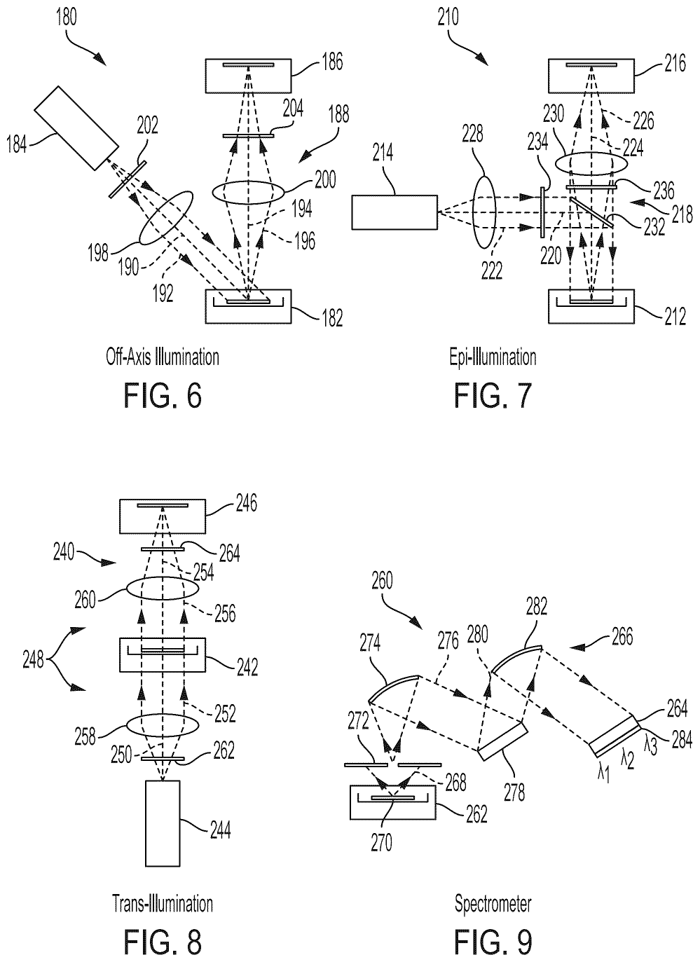

The illumination module, when present, generally comprises any structure configured to produce illumination light capable of irradiating a sample. The illumination module may include one or more light sources. These light sources may have the same or different spectral properties. Typically, different light sources will have different spectral properties, with each capable of inducing a desired or distinguishable response, such as color or fluorescence, from suitable samples at a different wavelength or range(s) of wavelengths. However, in some cases, two or more similar or identical light sources may be combined to produce higher-intensity excitation light. Exemplary light sources may include light-emitting diodes (LEDs), lasers, solid-state lasers, laser diodes, and superluminescent diodes (SLDs), among others. The light sources may be operated serially, for example, to induce different responses at different times, or simultaneously, for example, for multi-color or multiplexed detection. Embodiments that include an illumination module may be used for colorimetric analysis, absorption analysis, and/or fluorescence analysis, among others. Embodiments that do not include an illumination module, or that are operated with their illumination module off, may be used for chemiluminescence analysis or ambient light analysis, among others. Exemplary illumination modules are described further below in connection with FIGS. 6-8.

The detection module generally comprises any structure configured to detect light of suitable wavelength originating from a sample at the examination region. The detected light may arise directly in the sample (e.g., chemiluminescence). Alternatively, or in addition, the detected light may arise in response to illumination light. In some cases, the detected light may be the illumination light, after it has been scattered, reflected, diffracted, refracted, transmitted, or otherwise altered by the sample. The character of this light may be further affected by absorption of some of the light, for example, of selected wavelengths or wavelength bands, changing its color. In other cases, the detected light may be photoluminescence (e.g., fluorescence and phosphorescence) induced by the illumination light. The detection module may form an image of samples disposed in the sample holder, or a portion of the sample holder, such that light originating from different samples at different positions on the sample can be observed simultaneously. The detection module may form a single image of pertinent samples or multiple images (e.g., a series of images corresponding to different wavelength regimes). In the latter case, the images may be analyzed separately or combined (for example, after pseudo-coloring) to form a composite image. The image may be a minified image (i.e., smaller than the samples).

The wavelength sensitivity of the detection module may be from about 200 nm to about 2000 nm, or a subset or subsets thereof, depending on the embodiment. The sensitivity may exceed that of standard silicon-based detectors, especially at long wavelengths (because silicon detectors fail above about 1.1 μm, since longer-wavelength photons do not have enough energy to overcome silicon's band gap). Extending the detection wavelength above about 1.2 or 1.3 μm can significantly increase the dynamic range of the system. This, in turn, has two potential advantages. First, it allows detection from a larger number of sample types in a given analysis, because additional wavelengths may be used to label the additional sample types. Second, for a fixed number of sample types, it allows greater separation between the wavelengths associated with each sample type, reducing crosstalk and other cross-sample contamination. This means that Stokes shifts associated with excitation and emission of a given fluorophore can be increased, reducing the amount of excitation light erroneously collected with the emission. It also means greater separation between the excitation and emission for one fluorophore (used to label a first sample type) and the excitation and emission for another fluorophore (used to label a second sample type). However, there are difficulties associated with using longer wavelength light. In particular, objects spontaneously emit radiation. The amount of this spontaneous “thermal” emission at room temperature rises quickly with wavelength. It is still small at about 1.2 or 1.3 μm but can be large, relative to sample signals, by about 2 μm. Thus, when extending the detection range, especially at long wavelengths, there is an interplay between the advantages of increased multiplexing and the disadvantages of increased thermal noise. Significantly, the amount of thermal noise can be reduced by cooling system elements so that their emission at longer wavelengths is reduced relative to their emissions at room temperature. This, in turn, can make detection at longer wavelengths more worthwhile relative to noise. The benefits of cooling can be obtained by cooling some or all of the elements in the detection area of the detection module, including but not limited to the sample itself and any intervening filters, lenses, beamsplitters, or other optical elements. The system could also include a cutoff filter, preferably cooled, that blocked radiation having wavelengths higher than the maximum wavelengths to be detected from the sample. Cooling may be accomplished using any suitable mechanism, such as thermoelectric coolers (TECs) and/or circulating fluid, among others.

A suitable detector with the recited properties, including a large spectral range, may be constructed by combining a CMOS (or other) silicon-based image sensor with a suitable antenna layer capable of detecting light outside the range directly detectable by the image sensor alone and then converting it into a form that can be detected. In other words, at least some of the photon-to-charge conversion necessary for detection is performed by other materials, while portions of the underlying image sensor are also used. An exemplary approach uses graphene (or other optically transparent, high-conductivity polycrystalline material, for example, black phosphorous). The base comprises the addressing/readout layers of a conventional silicon image sensor (Read-Out Integrated Circuit, or ROIC). However, instead of having a photodiode in each pixel made of silicon with its band gap and hence spectral limitations, graphene is deposited, followed by quantum dots and/or other compounds that absorb the desired spectral range. Together, they act as a phototransistor. The result is photon-to-charge conversion. The graphene, produced by chemical vapor deposition (CVD) or other suitable technique, is deposited on top of a wafer containing many image sensor dies, for example, using a wet transfer process. The graphene forms a path from one pixel contact to another. This may be done by a pattern etching using a photoresist mask and oxygen plasma. Alternate structures are possible. To increase fill factor (i.e., the percentage of pixel area that captures light), the pixel electrodes could be lines along the pixel edges. Colloidal quantum dots (CQDs) with appropriate spectral absorbance characteristics are next placed over the graphene. Incoming photons produce a photoresponse (an electron-hole pair) when absorbed by the CQD layer. Holes transfer to the graphene due to a bias applied between the pixel contacts, leaving electrons to build up in the CQDs.

The optical relay structure generally comprises any structure configured to direct illumination light from the illumination module, when present, to samples at the examination region and to direct output light from the samples to the detection module. In its simplest form (in the absence of an illumination module), the optical relay structure may include a single lens positioned to collect light from the sample(s) and to focus the light, for example, to form an image, onto the detection module. More generally, the optical relay structure may include additional lenses, filters, mirrors, beamsplitters, and/or other optics, depending on the embodiment. However, they generally may be mixed and matched, as appropriate, depending on the usage. Exemplary optical relay structures, and components thereof, are described further below in connection with FIGS. 5-9.

Lenses may be positioned in the illumination path and/or the output path. These lenses may perform any suitable function. For example, a lens positioned in the illumination path may homogenize and collimate illumination light incident on the sample holder, such that its intensity is more uniform and/or it is more nearly parallel to the optical axis and/or perpendicular to a plane of the sample holder, reducing shadows. Alternatively, or in addition, a lens positioned in the output optical path may collect output light and direct it toward the detection module, increasing the amount of light captured by the detection module. The lens also may focus light onto the detection module to assist in image formation. Lenses in the optical relay structure may complement or supplement the role of lenses integral with the illumination module and/or detection module. The lenses may have any suitable properties, for example, converging or diverging. They may be simple lenses, compound lenses, or groups of lenses capable of performing the indicated functions. In some cases, compound lenses and/or groups of lenses may better reduce aberrations, such as spherical and/or chromatic aberrations, among others.

Filters may be used to adjust the quantity and/or quality of light. Neutral density filters, which generally affect all wavelengths similarly, may be used to alter the intensity of the illumination and/or output light before the light is incident on the sample(s) or detection module, respectively. Such filters may be placed in the illumination path, upstream from the sample, to alter the intensity of illumination light and in the output path, downstream from the sample, to alter the intensity of output light. Alternatively, or in addition, the intensity of the illumination light (and indirectly the output light) can be controlled by the illumination module itself, for example, by altering the strength and/or duration of power supplied to the light sources. Spectral filters, which generally affect different wavelengths or ranges of wavelengths differently, may be used to alter the spectral properties of both the illumination light and output light. For example, spectral filters positioned in the illumination path (e.g., excitation filters in fluorescence-based systems) may be used to alter the spectral properties of the illumination light, before it impinges on samples in the sample holder, generally by reducing or blocking light at selected wavelengths and/or ranges of wavelengths. Spectral filters positioned in the output path (e.g., emission filters in fluorescence-based systems) may be used to alter the spectral properties of the light incident on the detection module. This light is typically a combination of output light from samples and stray illumination light that unintentionally ends up in the output path. For example, in fluorescence-based systems, the emission filters may preferentially block excitation light, so the image generated by the detection module better represents only fluorescence emission light. This is possible, for single-photon excitation, because the excitation light generally has shorter wavelengths (higher frequencies) than the fluorescence emission light it induces. The emission filters also may block fluorescence emission light outside certain fluorescence wavelengths, for example, to reduce signal contributions from autofluorescence and/or other fluorophores involved in the analysis that are inadvertently excited by the excitation light (crosstalk). The illumination and output filters typically are chosen to work with specific light sources, beamsplitters (if dichroic or multi-dichroic beamsplitters are used), and fluorophores. In some cases, the filters may work with more than one light source and/or more than one fluorophore. For example, the filters may pass light in certain sets of wavebands and block light in other sets of wavebands (e.g., pass blue, block green, pass yellow, block red, or vice versa, among other combinations).

### II. Sample Holders

FIGS. 2-4 show three exemplary sample holders for use with different wide-spectrum analysis systems and with different types of analysis, including (A) gels and blots, (B) multi-well plates, and (C) microfluidic devices.

### II.A. Gels and Blots

FIG. 2 is a schematic view of a first exemplary sample holder 100, configured as a gel or blot, suitable for use with the analysis systems of the present disclosure. The gel or blot may have any suitable size or shape, consistent with the stage, and any suitable composition. The gel or blot may be used to separate and distinguish any suitable species, including DNA, RNA, proteins, and/or cellular components, among others. These separated species may appear as bands 102 on the gel or blot. Exemplary gels include agarose gels and polyacrylamide gels, among other. Exemplary blots, which may be generated from gels, include western blots (for proteins), northern blots (for RNA), and Southern blots (for DNA), among others. The gel or blot may be supported at the examination region in a tray or other suitable receptacle.

### II.B. Multi-Well Plates

FIG. 3 is a schematic view of a second exemplary sample holder 120, configured as a multi-well plate, such as a PCR plate or a microplate, suitable for use with the analysis systems of the present disclosure. The plate may have any suitable shape, such as square or rectangular, and any suitable composition, such as plastic. The plate may have any suitable number of sample wells 122, such as 96, 384, or 1536 sample wells, among others. The wells may have opaque bottoms, for use with self-luminous samples or with epi-illumination and detection (where the illumination and detection modules are of the same side of the plate). Alternatively, the wells may have clear bottoms, for use with trans-illumination and detection (where the illumination and detection modules are on opposite sides of the plate). Multi-well plates may be particularly suited for studying reactions, such as PCR and/or enzyme reactions, and the influence of (candidate) modulators on those reactions.

### II.C. Microfluidic Devices

FIG. 4 is a schematic view of a third exemplary sample holder 140, configured as a microfluidic device, suitable for use with the analysis systems of the present disclosure. The device may include one or more channels 142, reservoirs 144, input ports 146, and output ports 148, among other components. Samples may be supported in the fluid and routed from point to point through the channels. Sample analysis may occur at a discrete point or points in the device. In some cases, a light source and/or detector may be integral to the embodiment. Microfluidic devices may be particularly well suited for studying, and separating, cells, vesicles, and droplets, among others.

### III. Optical Relay Structures

FIGS. 5-9 show five exemplary wide-spectrum analysis systems, with particular emphasis on their optical relay structures. The systems all include stages and detection modules and differ based on the absence or presence of an illumination module and the details of their optical relay structures. Optical components, such as lenses and filters, are shown schematically. They may be simple unitary structures or compound structures, as appropriate. The relative positions and sizes of optical components, including light sources, lenses, and beamsplitters may be adjusted to increase or decrease the portion of the sample holder that is illuminated and/or to alter the quality of that illumination. Illumination light and output light are portrayed in the figures using lines that denote a centerline of the respective paths taken by the light. In actuality, both the illumination light and output light will generally fill a volume that may be clipped by windows or other apertures, shaped by lenses, and so on. Thus, the illumination light may fan out enough to illuminate most or all of the sample holder and the associated sample sites and samples. Output light, especially photoluminescence, may be emitted isotropically (except, for example, in some polarization assays). This description focuses on the subset of illumination light that ultimately irradiates the samples and the subset of output light that ultimately is detected by the detection module

III.A System with No Illumination

FIG. 5 is a schematic view of a first exemplary wide-spectrum analysis system 160. This system is distinguished by its lack of an illumination module. The system includes a stage 162, a detection module 164, and an optical relay structure 166. In this embodiment, the optical relay structure includes (1) a lens 168 configured to capture and direct output light 172 onto the detection module and (2) an optional filter 168 configured to alter an aspect (e.g., intensity and/or spectrum) of that light prior to its reaching the detection module. The filter, or filters, may be positioned before and/or after the lens, as appropriate or desired. Exemplary applications of this system include a chemiluminescence reader, for example, for gels, blots, and microplates, among others.

III.B System with Off-Axis Illumination

FIG. 6 is a schematic view of a second exemplary wide-spectrum analysis system 180. This system is distinguished by its off-axis illumination module. The system includes a stage 182, an illumination module 184, a detection module 186, and an optical relay structure 188. Here, the illumination path 190 taken by the illumination light 192 and the output path 194 taken by the output light 196 are angled relative to one another near the stage. The optical relay structure may include a first lens 198, such as a condenser lens, to direct light form the illumination module onto the stage and a second lens 200, such as an objective lens, to direct light from the stage to the detection module. The first lens may be positioned to homogenize and collimate the illumination light, for example, by being positioned at one focal length from the illumination module. The system may further include filters, such as an illumination filter 202 and an output filter 204, positioned in the illumination path and the output path, respectively, to condition the light prior to its hitting the sample or detection module. These filters may be positioned before and/or after the respective lenses in each path. Exemplary applications of this system include gel and blot readers, among others.

III.C System with Epi-Illumination

FIG. 7 is a schematic view of a third exemplary wide-spectrum analysis system 210. This system is distinguished by its epi-illumination module. The system includes a stage 212, an illumination module 214, a detection module 216, and an optical relay structure 218. Here, in contrast to the system in FIG. 6, the illumination path 220 taken by the illumination light 222 and the output path 224 taken by the output light 226 are colinear and anti-parallel relative to one another near the stage. The optical relay structure may include a first lens 228, such as a condenser lens, to direct light from the illumination module onto the stage and a second lens 230, such as an objective lens, to direct light from the stage to the detection module. The first lens may be positioned to homogenize and collimate the illumination light, for example, by being positioned at one focal length from the illumination module. The optical relay structure further includes a beamsplitter 232 configured to separate and direct illumination and output light. The beamsplitter may act similarly on all wavelengths, transmitting or reflecting a similar amount of illumination light and output light at least substantially independent of the wavelength of the light. Examples include partially silvered, including half-silvered (50:50), beamsplitters. Alternatively, the beamsplitter may act differently on different wavelengths, for example, preferentially reflecting illumination light and transmitting output light, or vice versa. Examples include dichroic beamsplitters and multi-dichroic beamsplitters. The beamsplitter may have any suitable shape, including a cube or a plate or slab. The beamsplitter may be non-polarizing or polarizing, depending on the type of use or assay. In the pictured embodiment, the beamsplitter reflects the illumination light toward the sample holder and transmits the output light toward the detector. However, in other embodiments, the beamsplitter may transmit the illumination light toward the sample holder and reflect the output light toward the detection module. The system may further include filters, such as an illumination filter 234 and an output filter 236, positioned in the illumination path and the output path, respectively, to condition the light prior to its hitting the sample or detection module. These filters may be positioned before and/or after the respective lenses in each path. They typically will be positioned between the illumination module and the beamsplitter and between the beamsplitter and the detection module, depending on whether they are intended to operate on the illumination light or the output light, respectively. Exemplary applications of this system include fluorescence-based gel and blot readers and fluorescence-based PCR and microplate readers, among others.

III.D System with Trans-Illumination

FIG. 8 is a schematic view of a fourth exemplary wide-spectrum analysis system 240. This system is distinguished by its trans-illumination module. The system includes a stage 242, an illumination module 244, a detection module 246, and an optical relay structure 248. Here, the illumination path 250 taken by the illumination light 252 and the output path 254 taken by the output light 256 are colinear and parallel relative to one another near the stage. The optical relay structure may include a first lens 258, such as a condenser lens, to direct light form the illumination module onto the stage and a second lens 260, such as an objective lens, to direct light from the stage to the detection module. The first lens may be positioned to homogenize and collimate the illumination light, for example, by being positioned at one focal length from the illumination module. The second lens may be positioned to collect the same collimated light, after it has passed through the sample, and to focus it on the detection module, for example, by being positioned at one focal length from the detection module. The system may further include filters, such as an illumination filter 262 and an output filter 264, positioned in the illumination path and the output path, respectively, to condition the light prior to its hitting the sample or detection module. These filters may be positioned before and/or after the respective lenses in each path. Exemplary applications of this system include absorption assays, among others, using any suitable sample holders (e.g., gels, blots, PCR plates, microplates, or microfluidic devices, among others).

III.A System with Spectral Separator

FIG. 9 is a schematic view of a fifth exemplary wide-spectrum analysis system 260. This system, which may be used with or without an illumination module, is distinguished by how it separates the output light spatially based on its spectral content (i.e., according to its wavelength). The system, as pictured, includes a stage 262, a detection module 264, and an optical relay structure 266. Output light 268 from a sample 270 impinges on a pinhole 272, which acts like a point source. A portion of the light exiting the pinhole hits a mirror 274, such as an off-axis parabolic mirror, which collimates the light and reflects the collimated light 276 onto a reflection diffraction grating 278. The grating splits the light according to color (ultraviolet, visible (violet, indigo, blue, green, yellow, orange, red), infrared). The spectrally separated light 280 is then reflected onto the detection module, maintaining the spatial relationships, using another suitable mirror 282. The detection module forms an image 284 of the spectrum, which may be continuous and/or discrete depending on the complexity of the sample. In other embodiments, the pinhole may be replaced by a slit, or an image of light exiting a pinhole or slit, or some other form of illumination, such as focused illumination, capable of being collimated before impinging on the grating. In some embodiments, the reflection diffraction gradient may be replaced by another suitable dispersive element, such as a transmission diffraction gradient or a prism, among others. In these embodiments, the mirrors may be configured differently, as appropriate. The system also may include lenses, but lenses can more easily introduce chromatic artifacts. This embodiment, in any of its forms, may be used with or without an illumination module, in the former case using off-axis, epi-, or trans-illumination, as appropriate.

### IV. Exemplary Images

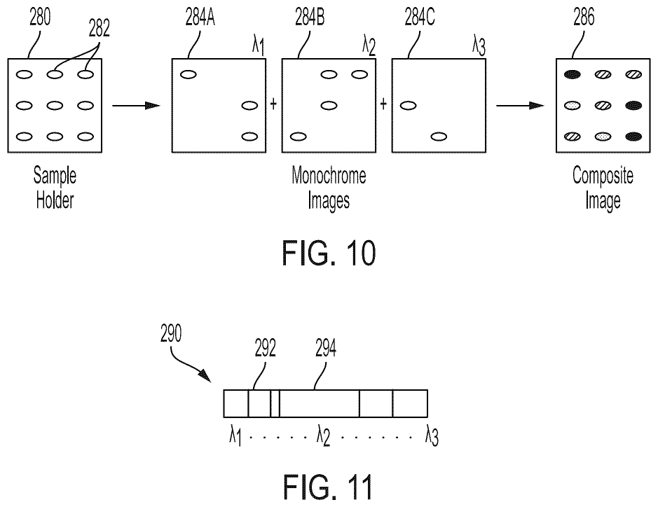

FIGS. 10 and 11 show schematic views of exemplary images formed by different embodiments of the wide-spectrum analysis system.

FIG. 10 is a schematic view of a sample holder containing a plurality of colored samples and two categories of images that may be formed of the samples using a wide-spectrum analysis system, in accordance with aspects of the present disclosure. The left panel shows an exemplary sample holder 280, such as a gel or blot or multiwell plate, with an array of samples 282. The middle panel shows a set of three “monochrome” images 284A,B,C, each corresponding to a different wavelength λ₁, λ₂, and λ₃. Here, each λᵢ may independently refer to a specific wavelength, or range of wavelengths centered around and/or peaking at λᵢ, detectable by the detection module. Each such image may be taken using appropriate illumination, if the illumination module is employed, and appropriate filters. The set of wavelengths may include UV and visible, visible and IR, or UV, visible, and IR, among others. The images may correspond to observed intensities at each wavelength (or wavelength range) or some other aspect(s) of the output light. Single images may be monochrome (e.g., grayscale). Images may be pseudocolored. In particular, images corresponding to UV and IR light will necessarily be pseudocolored (using human-recognizable colors), even in grayscale, because UV and IR light is invisible to the human eye. The right panel shows a composite image 286 formed by superimposing the monochrome images. In this case, each wavelength may be assigned a different shading or color or other designator to facilitate distinguishing samples at each wavelength λᵢ. The same principle can be applied to take any number of images at any number of wavelengths, or wavelength ranges, as long as they are sufficiently distinguishable (i.e., as long as there is a manageable level of crosstalk among the different wavelengths). Exemplary numbers of images that may be formed at different wavelengths may include 2, 3, 4, 5, 6, 7, 8, 9, or 10, among others.

FIG. 11 is a schematic view of an exemplary image of a spectrum of a colored sample, such as that which may be generated using the embodiment of FIG. 9, in accordance with aspects of the present disclosure. The image 290 shows intensity levels associated with each wavelength detectable by the detection module. Here, position along the long axis of the image corresponds to wavelength, At. For example, the left side of the image could correspond to ultraviolet light, the middle portion could correspond to visible light (in order, violet, blue, green, yellow, orange, and red), and infrared light. In other embodiments, the opposite order could be used. The spectrum can be discrete and/or continuous, depending on the complexity of the sample. For example, a single element might generate a series of discrete bands 292, corresponding to electronic transitions, while a compound or more complicated sample might generate broader bands 294, a combination of discrete bands and broader bands, or a fully continuous spectrum.

### V. Selected Embodiments

The wide-spectrum analysis systems presented herein may have a number of applications, including (A) fluorescence imagers, (B) PCR and microplate readers, (C) microfluidic devices, and (D) spectrometers, among others. Aspects of these applications are described below.

### V.A. Gel and Blot Imagers

The wide-spectrum analysis system may be configured as a gel or blot imager. Interrogation methods may include chemiluminescence, fluorescence, or colorimetry. The system may have a wide spectral range, 300-2500, or a subset thereof, all in a single system. Currently, to image visible and IR (if someone were even to consider it), you would need two distinct instruments. Moreover, no IR imagers are readily available due to cost. While IR cameras are available, there is no illumination and no ability to index the images with images taken with a visible light cameras. In contrast, the system of the present disclosure addresses these issues. Moreover, it may provide a variety of advantages. For example, in the context of fluorescence alone, the system may provide the following advantages:
(1) Longer wavelengths reduce background fluorescence, so to reduce background images may be taken with dyes excited by longer wavelength illumination.
(2) Longer Stokes shift dyes can be used with a sensor with such a large range. The Stokes shift is a measure of the wavelength difference between excitation light and emission light. A longer Stokes shift means that more typical fluorescence emission from non-target molecules will be out of the emission range of the dye and thus would not be seen as noise.
(3) A larger range allows reduced crosstalk. Current imagers typically allow no more than 3 colors on a single blot. Otherwise, multiplexing with adjacent channels allows emission from one channel to excite the next, or for a small emission signal to exist in the next channel.
(4) A larger range allows greater multiplexing. For example, blue, red, NIR normal, and 2 NIR into NIR II channels could allow a 5-plex blot, reducing the number of gels and blots that need to be made and run, and allowing multichannel images to be created easily.

An exemplary system, such as a wide-spectrum western blot system, may cut on around 415 nm and cut off around 1.4 μm. This cut-on wavelength allows its use with existing chemiluminescence substrates (one of which has emission peaking around 430 nm). In typical applications, the chemiluminescence substrate undergoes a reaction that causes it to emit light. The reaction may be mediated by an enzyme (or other activation agent) bound to an antibody (or other binding partner) that attaches, directly or indirectly, to a target molecule. In this way, the chemiluminescence reports on the location, and optionally the quantity, of the target. In some cases, the upper wavelength may be reduced, for example, to cut off around 1.2 μm or 1.3 μm, especially if the reduction significantly reduces the dark current relative to extending the range to 1.4 μm. This may be especially important in the absence of cooling.

### V.B. PCR and Microplate Readers

The wide-spectrum analysis system also may be configured as a PCR or microplate reader. These systems may have some or all of the advantages listed above (for gel and blot imagers), for example, reduced crosstalk and increased number of channels. Further applications to digital PCR are described below (under microfluidic devices).

### V.C. Microfluidic Devices

The wide-spectrum analysis system also may be configured as a microfluidic device. These devices may be constructed using any suitable mechanism and material. Examples include roll-to-roll or bonded injection-molded or injection-molded plastic bonded to glass, or PDMS to plastic or glass chips. Each may have microfluidic channels to direct and mix fluids. Moreover, direction through bubble generation or other valving techniques may be included. In some cases, the number of fluid channels may correspond to the number of fluorophores or other color indicators.

Illumination modules and detection modules may, independently, be separate from the device or part of the device. Light sources may be placed on one side of the device, such as the top, or bonded if flexible LEDs are used on a flexible circuit bonded to the chip. Sensors may be placed on the same or opposite side of the device, possibly with optical filtering layers between, depending on whether the device is being used for off-axis, epi-, or trans-illumination.

The microfluidic devices may take a number of forms. A first embodiment may be a cell analyzer where cells flow through and are excited and detected in different channels. Exemplary advantages are an increased number of channels and decreased crosstalk. A second embodiment may be a cytometer in which cells flow through and are excited and detected in different channels and then directed based on the results. Exemplary advantages are the same. A third embodiment may be a digital PCR machine, in which fluorescently labeled droplets go by the same excitation and detection apparatus as in the analyzer/cytometer above, again with the same advantages.

### V.D. Spectrometers

The wide-spectrum analysis system also may be configured as a spectrometer. A simple spectrometer or a fiber spectrometer may be created using hyperspectral filtering, placing discrete filters over known regions of the sensor, so that light reaching the detector at a given position corresponds to the bandpass of the filter at that position. A more complicated, but accurate, spectrometer may be created, as in FIG. 9, by using a dispersive element, such as a grating or prism, to spatially separate light according to wavelength. Either spectrometer may be used without extra illumination. Alternatively, either spectrometer may be used with illumination, by adding an illumination module, for example, to create a fluorescence spectrometer. Advantages of the spectrometer, especially the simple spectrometer, include lower cost.

### VI. Selected Aspects

This section describes selected aspects of the wide-spectrum fluorescence analyzer of the present disclosure as a series of indexed paragraphs.

1. A wide-spectrum analysis system, comprising (i) a stage configured to support a sample holder at an examination region; (ii) a detection module configured to detect output light produced by a sample positioned in the sample holder at the examination region, wherein the detection module can detect light having wavelengths between about 200 nm and about 2000 nm; and (iii) an optical relay structure configured to direct the output light from the examination region to the detection module.

1A. The system of paragraph 1, wherein the detection module can detect light having wavelengths between about 400 nm and about 1400 nm.

1B. The system of paragraph 1A, wherein the detection module can detect light having wavelengths between about 400 nm and about 1300 nm.

1C. The system of any of paragraphs 1-1B, wherein the detection module includes a sensor comprising a silicon-based sensor and an antenna layer, associated with the silicon, that allows the camera to detect longer-wavelength light than the silicon alone.

### Illumination Module

2. The analysis system of any of paragraphs 1-1C, further comprising an illumination module configured to produce illumination light for irradiating a sample positioned in the sample holder at the examination region.

2A. The analysis system of paragraph 2, wherein the optical relay structure is further configured to direct illumination light from the illumination module to the examination region.

2A1. The analysis system of paragraph 2A, wherein portions of the optical relay system that are used to direct illumination light to the examination region and portions that are used to direct output light from the examination region overlap.

2A2. The analysis system of paragraph 2A or 2A1, wherein the optical relay structure includes a filter to separate illumination light and output light.

2B. The analysis system of any of paragraphs 2-2A2, wherein the illumination module includes at least two distinct light sources.

2C. The analysis system of any of paragraphs 2-2B, wherein the illumination module includes at least one of an LED light source and a laser light source.

2D. The analysis system of any of paragraphs 2-2C, wherein the illumination module produces illumination light in at least two of the ultraviolet, visible, and infrared.

2E. The analysis system of paragraph 2D, wherein the illumination module produces illumination light in the ultraviolet, visible, and infrared.

2F. The analysis system of any of paragraphs 2-2E, wherein the sample is fluorescent, and the output light is fluorescence.

2G. The analysis system of any of paragraphs 2-2E, wherein the sample is colorimetric, and the output light is reflected, scattered, and/or transmitted by the sample.

2H. The analysis system of paragraph 2F or 2G, further comprising a sample disposed in the sample holder, wherein the sample is labeled with dyes that produce output light in at least two of the ultraviolet, visible, and infrared, and wherein the detection module can detect the output light.

2H1. The analysis system of paragraph 2H, wherein the sample is labeled with dyes that produce output light in the ultraviolet, visible, and infrared.

2H2. The analysis system of paragraph 2H or 2H1, wherein the sample is labeled with at least four dyes.

2H3. The analysis system of any of paragraphs 2H-2H2, wherein the dyes are fluorescent dyes.

2H4. The analysis system of any of paragraphs 2H-2H2, wherein the dyes are colorimetric dyes.

### MISCELLANEOUS

3. The analysis system of any of paragraphs 1-1C, wherein the sample is chemiluminescent, and the output light is chemiluminescence.

4. The analysis system of any of paragraphs 1-3, wherein the optical relay structure includes a lens capable of transmitting light having wavelengths between about 200 nm and 2000 nm.

4A. The analysis system of paragraph 4, wherein the lens comprises a material selected from the group consisting of UV fused silica, N-BK7, sapphire, calcium fluoride, magnesium fluoride, sodium fluoride, and potassium bromide.

5. The analysis system of any of paragraphs 1-4A, wherein the detection module is configured to form an image of one or more samples in the sample holder.

5A. The analysis system of paragraph 5, wherein the detection module forms a first image corresponding to output light of a first wavelength range and a second image corresponding to output light of a second wavelength range.

5A1. The analysis system of paragraph 5A, wherein the system combines the first image and the second image to form a composite image.

5A1a. The analysis system of paragraph 5A or 5A1, wherein the first image corresponds to visible output light and the second image corresponds to infrared output light.

6A. The analysis system of any of paragraphs 1-5A1a, wherein the sample is stationary while the detection module detects the output light.

6B. The analysis system of any of paragraphs 1-5A1a, wherein the sample moves while the detection module detects the output light.

7. The analysis system of any of paragraphs 1-6B, further comprising a processor configured to analyze the output light detected by the detection module.

8. The analysis system of any of paragraphs 1-7, further comprising a cooler configured to reduce the temperature of components in the line of sight of the detection module.

8A. The analysis system of paragraph 8, wherein the cooler is a thermoelectric cooler (TEC).

9. The analysis system of any of paragraphs 1-8, wherein the optical relay structure includes a filter that blocks light with wavelengths longer than the longest wavelength intended to be detected by the analyzer.

10. The analysis system of any of paragraphs 1-9, wherein at least one of the sample and a portion of the optical relay system is cooled to reduce the amount of thermal radiation it emits that can be detected by the detection module.

10A. The analysis system of paragraph 10, wherein the cooling reduces the temperature of the cooled item below room temperature.

10B. The analysis system of paragraph 10 or 10A, wherein the portion of the optical relay structure that is cooled includes at least one of a lens and a filter positioned in front of the detection module.

10B.1 The analysis system of paragraph 10B, wherein the portion is a lens.

10B.2 The analysis system of paragraph 10B, wherein the portion is a filter.

10C. The analysis system of paragraph 10 or 1A, wherein the sample is cooled.

### Fluorescence Imagers

A. The analysis system of any of paragraphs 1-7, wherein the sample holder is a gel or a blot.

A1. The analysis system of paragraph A, wherein the sample is a blot.

A1a. The analysis system of paragraph A1, wherein the sample is a western blot.

A2. The analysis system of paragraph A, wherein the sample is a gel.

A4. The analysis system of any of paragraphs A-A3, wherein the stage is configured to support at least two gels or at least two blots for simultaneous analysis.

A5. The analysis system of any of paragraphs A-A4, wherein the processor includes instructions to take images automatically and/or to identify and process image features such as the location and intensities of bands.

### PCR and Microplate Readers

B. The analysis system of any of paragraphs 1-7, wherein the sample holder is a multi-well plate.

B1 The analysis system of paragraph B, wherein the sample holder is a PCR plate.

B1a. The analysis system of paragraph B1, wherein the stage further includes heating blocks for cycling the temperature of samples disposed in the sample holder.

B2. The analysis system of paragraph B1 or B1a, wherein the sample comprises amplified nucleic acids.

B3. The analysis system of paragraph B, wherein the sample holder is a microplate.

B4. The analysis system of any of paragraphs B-B3, wherein the processor includes instructions to take images automatically and/or to assess an extent of a reaction in the sample.

### Opto-Fluidic Devices

C. The analysis system of any of paragraphs 1-7, wherein the sample holder is a microfluidic device.

C1. The analysis system of paragraph C, wherein the sample is selected from the group consisting of aqueous droplets, vesicles, organelles, and cells.

C2. The analysis system of paragraph C or C1, wherein the microfluidic device includes a plurality of channels, each channel configured to support a sample, wherein output light from each sample can be detected simultaneously.

C2a. The analysis system of paragraph C2, wherein the samples are moved through the channels, and detection occurs while the samples are moving.

C2b. The analysis system of paragraph C2 or C2a, wherein the microfluidic device can direct each sample into a specific one of at least two channels based on a characteristic of the output light.

C2b1. The analysis system of paragraph C2b, wherein the sample is a cell.

C2b2. The analysis system of paragraph C2b, wherein the sample is a droplet.

C3a. The analysis system of any of paragraphs C-C2b2, further comprising an illumination module, wherein the illumination module is attached to the microfluidic device.

C3b. The analysis system of any of paragraphs C-C2b2, further comprising an illumination module, wherein the illumination module is separate from the microfluidic device, such that the same illumination module can be used with a plurality of microfluidic devices.

C4. The analysis system of any of paragraphs C-C3b, wherein the detection module is positioned below the sample holder.

C5. The analysis system of paragraph C4, wherein a spectral filter is positioned between the sample holder and the detection module.

C6. The analysis system of any of paragraphs C-C5, wherein the processor includes instructions to identify samples and to direct them into different channels based on the identification.

### Spectrometers

D. The analysis system of any of paragraphs 1-7, wherein the optical relay system separates the output light spatially according to wavelength before the light is detected by the detection module.

D0. The analysis system of paragraph D, wherein the output light is separated by a hyperspectral filter placed in the light path, so that light incident on a given portion of the detection module corresponds to light that passes through a given portion of the filter.

D1. The analysis system of paragraph D, wherein the output light is separated by a grating.

D2. The analysis system of paragraph D, wherein the output light is separated by a prism.

D3. The analysis system of any of paragraphs D-D2, wherein the detection module forms an image of the spectrally separated output light.

D4. The analysis system of any of paragraphs D-D3, wherein the processor includes instructions to identify the wavelengths and relative intensities of separated output light.

### Methods

M. A method of analyzing a multi-sample system, comprising (i) selecting the wide-spectrum analysis system of any of paragraphs 1-D4; (ii) collecting data at a set of wavelength regimes spanning at least a portion of the wavelengths detectable by the system; and (iii) forming one or more images based on the collected data.

M1. The method of paragraph M, wherein the set of wavelength regimes spans at least 700 nm.

M2. The method of paragraph M or paragraph M1, wherein the set includes at least 4 wavelength regimes.

M2A. The method of paragraph M2, wherein the set includes at least 5 wavelength regimes.

M2B. The method of paragraph M2A, wherein the set includes at least 6 wavelength regimes.

M3. The method of any of paragraphs M-M2B, wherein the set of wavelength regimes includes at least two of the ultraviolet, the visible, and the infrared.

M3A. The method of paragraph M3, wherein the set of wavelength regimes includes all three of the ultraviolet, the visible, and the infrared.

The term “exemplary” as used in the present disclosure means “illustrative” or “serving as an example” and does not imply desirability or superiority.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure. Further, ordinal indicators, such as first, second, or third, for identified elements are used to distinguish between the elements, and do not indicate a particular position or order of such elements, unless otherwise specifically stated.

1. A wide-spectrum analysis system, comprising:
a stage configured to support a sample holder at an examination region;
a detection module configured to detect output light produced by a sample positioned in the sample holder at the examination region, wherein the detection module can detect light having wavelengths between about 200 nm and about 2000 nm; and
an optical relay structure configured to direct the output light from the examination region to the detection module.

2. The system of claim 1, wherein the detection module can detect light having wavelengths between about 400 nm and about 1400 nm.

3. The system of claim 2, wherein the detection module can detect light having wavelengths between about 400 nm and about 1300 nm.

4. The system of claim 1, wherein the detection module includes a sensor comprising a silicon-based sensor and an antenna layer, associated with the silicon, that allows the camera to detect longer-wavelength light than the silicon alone.

5. The analysis system of claim 1, further comprising an illumination module configured to produce illumination light for irradiating a sample positioned in the sample holder at the examination region.

6. The analysis system of claim 5, wherein the optical relay structure is further configured to direct illumination light from the illumination module to the examination region.

7. The analysis system of claim 6, wherein portions of the optical relay system that are used to direct illumination light to the examination region and portions that are used to direct output light from the examination region overlap.

8. The analysis system of claim 6, wherein the optical relay structure includes a filter to separate illumination light and output light.

9. The analysis system of claim 5, wherein the illumination module includes at least two distinct light sources.

10. The analysis system of claim 5, wherein the illumination module includes at least one of an LED light source and a laser light source.

11. The analysis system of claim 5, wherein the illumination module produces illumination light in at least two of the ultraviolet, visible, and infrared.

12. The analysis system of claim 11, wherein the illumination module produces illumination light in the ultraviolet, visible, and infrared.

13. The analysis system of claim 5, wherein the sample is fluorescent, and the output light is fluorescence.

14. The analysis system of claim 13, further comprising a sample disposed in the sample holder, wherein the sample is labeled with dyes that produce output light in at least two of the ultraviolet, visible, and infrared, and wherein the detection module can detect the output light.

15. The analysis system of claim 14, wherein the sample is labeled with dyes that produce output light in the ultraviolet, visible, and infrared.

16. The analysis system of claim 15, wherein the sample is labeled with at least four dyes.

17. The analysis system of claim 5, wherein the sample is colorimetric, and the output light is reflected, scattered, and/or transmitted by the sample.

18. The analysis system of claim 17, further comprising a sample disposed in the sample holder, wherein the sample is labeled with dyes that produce output light in at least two of the ultraviolet, visible, and infrared, and wherein the detection module can detect the output light.

19. The analysis system of claim 18, wherein the sample is labeled with dyes that produce output light in the ultraviolet, visible, and infrared.

20. The analysis system of claim 19, wherein the sample is labeled with at least four dyes.

21. The analysis system of claim 1, wherein the sample is chemiluminescent, and the output light is chemiluminescence.

22. The analysis system of claim 1, wherein the optical relay structure includes a lens capable of transmitting light having wavelengths between about 200 nm and 2000 nm.

23. The analysis system of claim 22, wherein the lens comprises a material selected from the group consisting of UV fused silica, N-BK7, sapphire, calcium fluoride, magnesium fluoride, sodium fluoride, and potassium bromide.

24. The analysis system of claim 1, wherein the detection module is configured to form an image of one or more samples in the sample holder.

25. The analysis system of claim 24, wherein the detection module forms a first image corresponding to output light of a first wavelength range and a second image corresponding to output light of a second wavelength range.

26. The analysis system of claim 25, wherein the system combines the first image and the second image to form a composite image.

27. The analysis system of claim 25, wherein the first image corresponds to visible output light and the second image corresponds to infrared output light.

28. The analysis system of claim 1, wherein the sample is stationary while the detection module detects the output light.

29. The analysis system of claim 1, wherein the sample moves while the detection module detects the output light.

30. The analysis system of claim 1, further comprising a processor configured to analyze the output light detected by the detection module.

31.-76. (canceled)
